(19) United States
(12) Patent Application Publication
(10) Pub. No.: US 2016/0274962 A1
(43) Pub. Date: Sep. 22, 2016

(54) Self-Tuning Troubleshooting Scripts

(71) Applicant: Alcatel-Lucent USA Inc., Murray Hill, NJ (US)

(72) Inventors: Steven J. Fortune, Summit, NJ (US); John Hobby, Piscataway, NJ (US)

(73) Assignee: ALCATEL-LUCENT USA INC., Murray Hill, NJ (US)

(21) Appl. No.: 14/662,731

(22) Filed: Mar. 19, 2015

(51) Int. Cl. G06F 11/07

(52) U.S. Cl. CPC G06F 11/079; G06F 11/0709; G06F 11/0751; G06F 11/0787

(57) ABSTRACT

A scripting language, scripting-language execution environment and methodology is provided that allows for the self-tuning of troubleshooting scripts and, in particular, to allow for the execution of the troubleshooting workflow in an order that will resolve the user's troubleshooting issue with improved accuracy and speed.

### TECHNICAL FIELD

The present invention relates generally to workflow processing, and, more particularly, to providing a scripting language, scripting-language environment and methodology that allows troubleshooting scripts to self-tune thereby optimizing troubleshooting actions responsive to a particular troubleshooting issue.

### BACKGROUND OF THE INVENTION

Today, it is estimated there are over five (5) billion broadband-enabled devices connected to communications networks, and more than one (1) billion mobile broadband users. As the number of devices, applications, and services that are connected to and provided by communications networks increases, the resulting complexity is driving up operational costs for service providers and putting increased pressure on their ability to consistently provide a high level customer experience. In many markets, service provider offerings are very similar and the overall customer experience provided has become an important competitive differentiator. Given that customers have various service provider offerings to choose from, and can more easily switch between service providers, they have come to expect and demand a high level of technical support when encountering a problem with their service (including the supporting hardware and software). To succeed in such a rapidly changing market, service providers and operators need new differentiators to remain competitive, to distinguish their high-value service offerings from others, and succeed with customer experience solutions that make their services easier to buy, own, use and maintain.

In order to address the delivery of high quality customer service, service providers utilize large scale service platforms that automate and remotely manage key interactions throughout the customer experience lifecycle, and across multiple services, networks and devices. In this way, the service providers can attempt to provide a consistent, unified experience for their new and existing customers that accelerates the rollout of new or modified services, reduces operational costs, drives profitable revenues and builds lasting brand loyalty.

These service platforms give customer service representatives the visibility, key information and management capabilities needed to quickly setup and manage new services, and diagnose and resolve service issues. A robust service management interface includes diagnostic intelligence and other relevant information about a customer's service from multiple sources such as the customer's device, the provider's network, third-party or partner systems, and back-office systems. Typically such platforms attempt to simplify diagnostics and service troubleshooting by providing these customer service representatives with access to service management actions based on pre-built workflows. Using such pre-built workflows, call center representatives can quickly pinpoint issues and take real-time corrective action to resolve customer technical issues or complaints.

These pre-built workflows are generally developed and defined utilizing so-called troubleshooting scripts that are directed to assisting with the resolution of technical issues (e.g., lack of internet connectivity from a home personal computer, lack of mobile broadband connectivity or lack of video services, to name just a few). Scripts are programs written for a special run-time environment that can interpret (or compile) and automate the task execution. Execution of the scripts guide the customer service agent who is engaged with the customer (or user) with a set of actions that the customer can take to resolve the technical issue (e.g., reconnecting cables, rebooting the user device, etc.), or may also contain resolution steps that the service provider can take directly (e.g., run network diagnostics, reset network elements, etc.). Alternatively, the user may interact directly with the troubleshooting scripts through an available web interface offered by the service provider. In either case, the scripts must be general and inclusive enough to resolve the user's issue based only on the so-called call driver (i.e., the high-level description of the technical issue from the user's viewpoint) even though there could be several possible causes of that call driver.

Existing troubleshooting scripts are typically described in a special-purpose programming language known as a scripting language or script language. These scripting languages provide the usual programming features (e.g., variables, conditionals, semantics, control structure, etc.) and are often viewed as a domain-specific language for a particular environment while operating at a high level of abstraction thereby making them ideally suited for script development. Some well-known examples of scripting languages include ECMAScript® for web browsers (e.g., JavaScript® is a well-known implementation thereof), Visual Basic® for applications or Bash for Unix® operating systems. Of course, given the specificity of a particular operator's service environment it can also be the case that the operator will define their own scripting language for script development.

In any case, due to the variety and complexity of technical issues that might arise in customer service delivery it is sometimes challenging to allow for a high degree of specialization. For example, changing the order of troubleshooting steps as a function of a particular user's equipment or service plan requires specialization and needs explicit programming. That is, script execution in a particular customer service context may execute steps that are not necessary to that customer's identified issue thereby decreasing overall responsiveness and customer satisfaction.

Therefore, a need exists for an improved scripting language, scripting-language environment and methodology that will increase the overall effectiveness of troubleshooting scripts and execution of troubleshooting actions defined by such scripts.

### BRIEF SUMMARY OF THE EMBODIMENTS

In accordance with various embodiments, a scripting language (or workflow definition language), scripting-language execution environment and methodology is provided that allows for self-tuning (i.e., self-contained, real-time, on-the-fly processing) of troubleshooting scripts to a user's specific context and, in particular, to allow for the execution of the troubleshooting workflow, defined by one or more troubleshooting scripts, in an execution order that will most likely resolve the user's troubleshooting issue with improved accuracy and speed.

In accordance with an embodiment, a work flow of existing troubleshooting scripts or newly created troubleshooting scripts is represented by one or more so-called “chunks” where chunks are programmable fragments specific to workflows that enable automated analysis. That is, as defined herein, a chunk is a self-contained, re-orderable workflow fragment which can either resolve or fail. Additionally, in accordance with alternative embodiments, a chunk may be further defined to have a semantic structure as follows: (i) a gate: establishes relevance (or applicability) of an action, that is, it determines whether an action is possible and practical in a current context; (ii) an action: an operation that might resolve a specific issue; and (iii) a verification: identifies whether or not that specific issue is resolved; the verification may be different for each chunk or may be the same across a defined set of chunks. As such, in accordance with the embodiment, the overall scripting-language execution environment incorporates a number of features and methodology.

For each troubleshooting script, the actions that might resolve a user's particular issue are identified and encapsulated by one or more chunks where the programming environment and chunk structure allow for various execution orders of the chunks. In general, there are many such actions associated with a single troubleshooting architecture. Each action, when executed, will report an explicit indication of resolution (i.e., success or failure). Further, context information that is relevant to a particular troubleshooting issue is identified and made available in the form of an execution variable. Context variables, in accordance with various embodiments, include hardware type (e.g., modem make/model), service type (e.g., ADSL or cable) and customer support level (e.g., low, medium, high).

For each troubleshooting issue (also referred to herein as a “call driver”), and for each execution session with that call driver, the scripting-language execution environment records the troubleshooting session and, at a minimum, records the context variables at the start of the session and the action taken to resolve the issue, including the success or failure of each action. Further, for each call driver, the history of past troubleshooting session(s) is used to train a processor that predicts an optimal chunk execution sequence, execution times, and resolution rate of each action. In accordance with further embodiments, past troubleshooting sessions together with a particular user context (i.e., current context variables) are utilized to predict the best resolution path (i.e., chunk execution success probability). In accordance with an embodiment, machine learning (e.g., logistic regression) is utilized by the prediction engine.

The utilization of chunks to represent the workflow allows for a script execution environment and platform that combines the use of such chunk workflow representation with contextual information and a prediction/learning methodology that results in the self-tuning of the chunks. That is, the selection of and execution order of chunks is accomplished in a real-time, self-contained fashion and is highly optimized. Advantageously, representation of the workflow using chunks and optimizing the execution order of such chunks delivers a troubleshooting script environment with improved customization, effectiveness and reduction in resolution times.

In accordance with an embodiment, a user's context may include information specific to the user (e.g., home equipment or service plan) and/or the user's past troubleshooting history. The context information, in the form of context variables, may also include information specific to the operator (e.g., known outages or other network problems), or may include the results of attempted resolution for a current troubleshooting session.

In accordance with an embodiment, the machine learning prediction engine can use the troubleshooting history to predict other aspects of the expected behavior of actions, for example, predicting the execution time of each action using past execution history. In accordance with an embodiment, the order of chunk (or action) execution could be modified or specified by the ratio of resolution probability over execution time.

In accordance with an embodiment, the scripting-language execution environment incorporates various constraints applied to the execution order of chunks (or actions). For example, a constraint might be defined to require a particular action only be executed if another action has already been attempted (e.g., an update action followed by a reboot action).

These and other advantages of the embodiments will be apparent to those of ordinary skill in the art by reference to the following detailed description and the accompanying drawings.

### BRIEF DESCRIPTION OF THE DRAWINGS

FIG. 1 shows an illustrative workflow for a representative call driver using a conventional scripting language;

FIG. 2 shows the illustrative workflow of FIG. 1 using chunks in accordance with an embodiment;

FIG. 3 shows a scripting-language execution environment for executing chunk workflows in accordance with an embodiment;

FIG. 4 shows a flowchart of illustrative operations for self-tuning troubleshooting scripts in accordance with an embodiment;

FIG. 5 shows an illustrative schematic block diagram of a troubleshooting workflow environment in accordance with an embodiment; and

FIG. 6 is a high-level block diagram of an exemplary computer in accordance with an embodiment.

### DETAILED DESCRIPTION

In accordance with various embodiments, a scripting language (or workflow definition language), scripting-language execution environment and methodology is provided that allows for the self-tuning of troubleshooting scripts to a user's specific context and, in particular, to allow for the execution of the troubleshooting workflow, defined by one or more troubleshooting scripts, in an order that will most likely resolve the user's troubleshooting issue with improved customization, accuracy and speed.

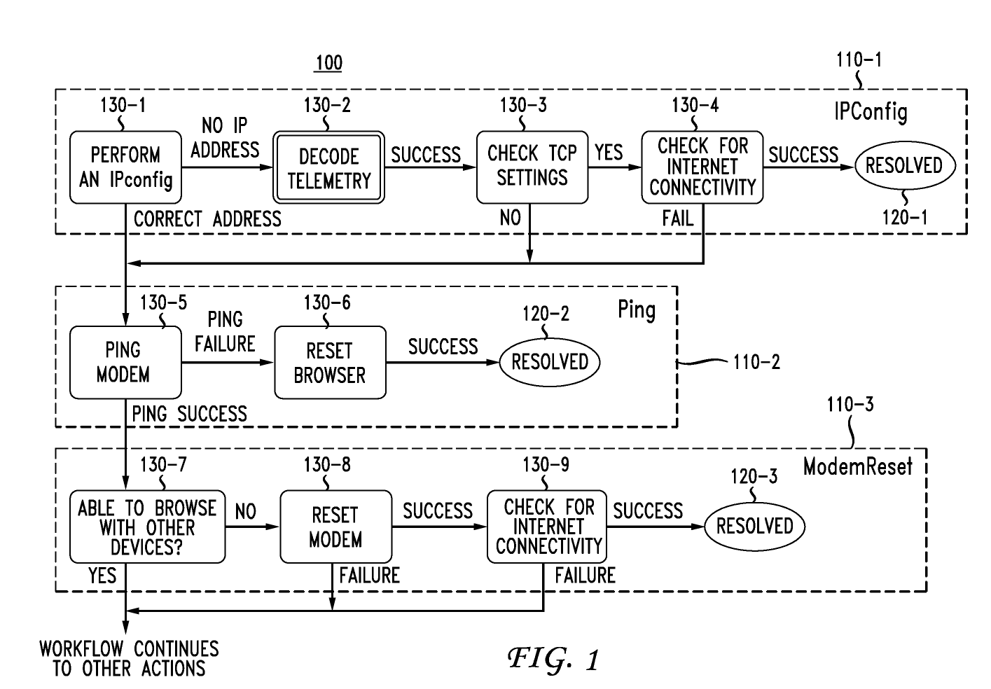

FIG. 1 shows an illustrative troubleshooting workflow for a particular call driver using a conventional scripting language. As shown, workflow 100 is, illustratively, directed to resolving a customer problem (i.e., call driver) with respect to Internet connectivity. Workflow 100 is a so-called “diagnose/resolve” workflow in that it is directed to resolving an identified customer problem (here, Internet connectivity) and would be part of a larger overall workflow covering the entire customer service troubleshooting delivery system. As such, workflow 100 is invoked when, for example, a customer calls customer support with an issue related to their Internet connectivity. Invocation of workflow 100 will initiate execution of one or more subroutines, e.g., subroutines 110-1 through 110-3, in an effort to guide the customer service representative in resolving the issue. Each subroutine has a set of one for more actions, i.e., actions 130-1 through 130-9, which may be invoked to resolve the troubleshooting issue. As shown, workflow 100 also has one or more resolution nodes, e.g., resolution nodes 120-1 through 120-3, which will terminate at least that portion of workflow 100 in the event of a resolution, such resolution is ideally a solving of the identified customer problem, but could also have other possibilities such as escalating the customer call to a higher support level or transferring the workflow to a different portion of the workflow.

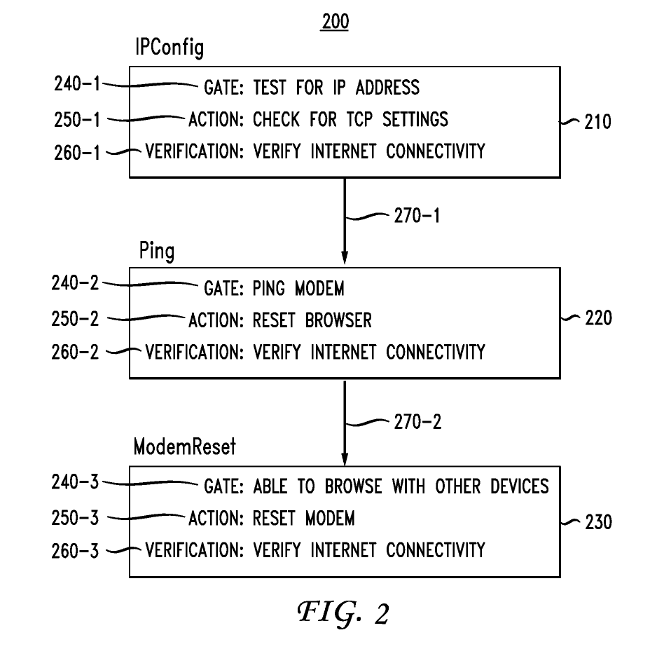

In accordance with various embodiments, the details of which will be further discussed herein below, the aforementioned Internet connectivity workflow can be defined by a plurality of chunks and workflow execution can be optimized in a variety of ways. FIG. 2 shows an illustrative workflow 200 for the call driver of FIG. 1 using chunks in accordance with an embodiment. That is, workflow 200 recasts workflow 100 using chunks in accordance with the embodiments herein. As shown, workflow 200 is directed to the same Internet connectivity workflow but is defined by the plurality of chunks, i.e., chunks 210, 220, and 230, and a plurality of paths, i.e., paths 270-1 through 270-2. Also, for simplicity of discussion herein, chunks 210, 220 and 230 are shown in FIG. 2 with a single exit point but it will be understood that a chunk herein has a single entry point and can have multiple exit points (i.e., multiple paths), one of which is indicative of resolution.

Again, as defined herein and in accordance with various embodiments, a chunk is a self-contained, re-orderable workflow fragment which can either resolve or fail. Additionally, in accordance with alternative embodiments, a chunk may be further defined to have a semantic structure as follows: (i) a gate: establishes relevance (or applicability) of an action, that is, it determines whether an action is possible and practical in a current context; (ii) an action: an operation that might resolve a specific issue—essentially a workflow step that modifies something as a resolution attempt; and (iii) a verification: identifies whether or not that specific issue is resolved—a workflow step that tests whether the action identified led to a resolution; the verification may be different for each chunk or may be the same across a defined set of chunks. If a chunk resolves the current issue (i.e., call driver) at least that portion of the workflow can terminate, otherwise, if a chunk fails to resolve the issue the workflow continues to other chunk(s). A chunk can utilize any typical so-called node type (e.g., question, exclusive-or, service operation, script node, etc.). A chunk has a single entry point and can have multiple exit points. One exit point is indicative of resolution and the other exit points are indicative of non-resolution (and that the workflow should continue with other chunk(s)). The utilization of chunks to represent the workflow allows for a script execution platform that combines the use of such chunk workflow representation with contextual information and a prediction/learning methodology that results in the self-tuning of the chunks. That is, the selection and execution order of chunks is highly optimized. To further facilitate an understanding of the various embodiments herein, an illustrative chunk will now be discussed.

In essence, in accordance with various embodiments, a chunk as defined above and as used herein is a special type of subroutine. FIG. 2 shows chunk 210 (named “IPConfig”) which is a chunk directed to an IP configuration call driver, for example, when a new customer reports an interconnectivity issue. As shown, chunk 210 has the aforementioned semantic structure defined by gate 240-1, action 250-1 and verification 260-1. In accordance with this example, gate 240-1 is directed to determining whether an IP address is detected or not. Here, chunk 210 will begin execution only if the IP address test (i.e., as defined by gate 240-1) indicates that there is no such IP address. Chunk 210 has action 250-1 which is a defined workflow step to do, or change, something in an attempt to resolve the call driver. Here, action 250-1 is directed to a checking TCP settings action for such purpose. Verification 260-1 of chunk 210 is directed to a workflow step for testing whether action 250-1 led to a resolution or not. So, if the TCP settings are configured properly (as per action 250-1) then verifying Internet access (as per verification 260-1) by the customer will determine such resolution. If successful, a resolution node is reached.

In the event there is no such resolution, as shown in FIG. 2, chunk 220 (named “Ping”) and chunk 230 (named “ModemReset”) may be executed for attempted troubleshooting resolution. That is, chunk 220 has gate 240-2 which is directed to a pinging operation. If a ping sent to the modem (i.e., the customer's modem) is successful, as determined in accordance with gate 240-2, then chunk 220 is unnecessary and processing will flow to chunk 230. If, however, the ping is unsuccessful then chunk 220 will execute and continue with action 250-2 which is a reset browser operation and verification 260-2 for checking Internet connectivity. If resolved, a resolution node is reached.

If, however, the execution of chunk 220 was unsuccessful in resolution of the troubleshooting issue, execution passes to chunk 230 with gate 240-3 which is to check whether the customer is able to browse with other devices. If not, execution of chunk 230 is needed and action 250-3 will direct that a modem reset be performed with verification 260-3 checking for Internet connectivity. If successful, a resolution node is reached. If not successful, the troubleshooting workflow continues with other chunks (not shown in FIG. 2) until a resolution is made of the customer's issue.

Advantageously, the utilization of chunks to represent the workflow allows for a scripting-language execution environment that combines the use of such chunk workflow representation with contextual information and a prediction/learning methodology that results in the self-tuning of the chunks. That is, the selection and execution order of chunks occurs in real-time and is highly optimized. The representation of the workflow using chunks and optimizing the execution order of such chunks delivers a troubleshooting script environment with improved customization, effectiveness and reduction in resolution times for user issues.

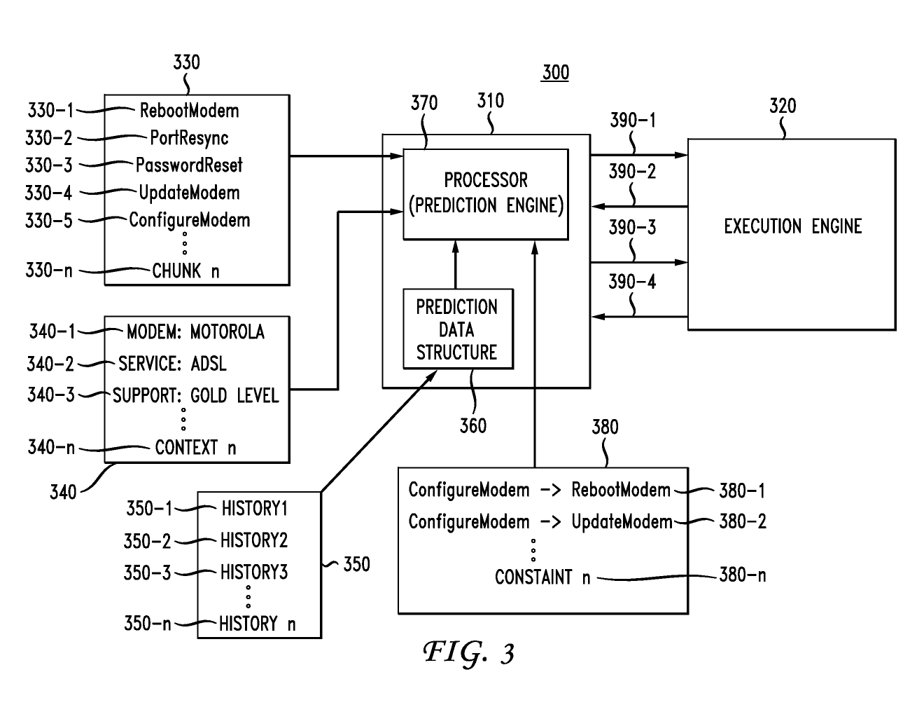

More particularly, FIG. 3 shows scripting-language execution environment 300 for operating with and executing chunk workflows in accordance with an embodiment. In accordance with various embodiments, scripting-language execution environment 300 incorporates chunks 330, context 340, constraints 380, history 350, and next-best-action engine (NBA) 310 to deliver self-tuning chunks and an optimized chunk workflow and execution thereof. In accordance with the embodiment, chunks 330 define a plurality of individual chunks, i.e., chunk 330-1 through 330-n, that are directed to specific call drivers. For example, as shown in FIG. 3, chunk 330-1 (named “RebootModem”) is directed to a modem reboot, chunk 330-2 (named “PortResync”) is directed to port synchronization, chunk 330-3 (named “PasswordReset”) is directed to password resetting, chunk 330-4 (named “UpdateModem”) is directed to modem updating and chunk 330-5 (named “ConfigureModem”) is directed to modem configuration.

In optimizing the selection and execution order of chunks, e.g., chunks 330-1 through 330-n, contextual information is utilized as represented by context 340. In accordance with an embodiment, a user's context may include information specific to the user (e.g., home equipment or service plan) and/or the user's past troubleshooting history. Context 340 is comprised of a plurality of context variables 340-1 through 340-n and may also include information specific to the operator (e.g., known outages or other network problems, or may include the results of attempted resolution for a current troubleshooting session). As shown, context 340 includes context variables 340-1 through 340-3 that, illustratively, detail specific hardware type (i.e., context variable 340-1), service type (i.e., context variable 340-2) and support level (i.e., context variable 340-3) for a particular user context.

As such, for each call driver (or troubleshooting issue), and for each session with that call driver, script-language execution environment 300 will record the troubleshooting session and, in particular, record the context variables (e.g., context variables 340-1 through 340-n) at the beginning of such troubleshooting session and actions taken to resolve the issue (e.g., chunk execution), including recording the success or failure of each action taken. Of course, as will be appreciated, in addition to examining the chunks for optimal operation and performance, it may also be the case that the chunks are examined in a so-called “learning” mode to understand chunk behavior in certain contexts, for example. Such learning is useful for understanding individual chunk behavior and may also contribute to enhanced workflow construction.

Context 340 serves as input to a so-called next-best-action (NBA) engine 310 which includes, illustratively, processor 370 and prediction data structure 360. In accordance with the embodiment, processor 370 will use troubleshooting history 350 to predict other aspects of the expected behavior of actions (i.e., chunks 330), for example, predicting the execution time of each chunk (e.g., chunks 330-1 through 330-3) using past execution history. Troubleshooting history 350 includes a record of past execution histories (i.e., the plurality of past history 350-1 through past history 350-n) that is a troubleshooting history for a particular call driver. Illustratively, troubleshooting history 350 is input, in whole or in part, into prediction data structure 360 (e.g., a data array or hash table) accessible by processor 370, illustratively, executing a prediction engine.

Illustratively, processor 370 utilizes logistic regression, a well-known machine learning technique, to formulate the predications described in various embodiments herein. As will be appreciated, other well-known machine learning techniques may also be used such as bayesian analysis, decision trees, nearest neighbor classification, and clustering, to name just a few. In accordance with the embodiment, the order of chunk (or action) execution could be modified or specified by the ratio of resolution probability over execution time. That is, in accordance with the embodiment, when a user has a troubleshooting issue with a specific call driver, scripting-language execution environment 300 will employ processor 370 to predict an expected resolution rate of each possible action (i.e., the plurality of chunks 330-1 through 330-n) and an execution order of the plurality of chunks 330-1 through 330-n from most likely to succeed to least likely to succeed. In addition, processor 370 (illustratively, executing a prediction engine) may also provide for self-tuning chunks in accordance with a desired business metric (such as call handling time, reducing escalation rate to higher support levels, and/or improving customer satisfaction, to name just a few) using context information.

For example, processor 370, in accordance with the above-described chunks 330, context 340 and history 350, might determine that for a particular sequence of chunks that chunk 330-5 should be executed first in an attempt to resolve a particular call driver and then chunk 330-1. That is, in general, the use of constraints imposes a condition that chunk “A” cannot be executed until chunk “B” is executed. Further, chunk A may have certain execution prerequisites, for example, related to chunk “B”, chunk “C” and/or chunk “D” such that the constraint is defined, for example, in a Boolean fashion to require execution of chunk B, chunk C (and) chunk D (before) chunk A.

As such, NBA engine 310 has a communication dialogue with execution engine 320, illustratively, via communications channel 390-1 through 390-4. For example, NBA engine 310 might suggest via communication channel 390-1 that chunk 330-5 be executed and execution engine 320 will return a result via communication channel 390-2. In the event of a failed result, NBA engine 310 might then suggest, via communication channel 390-3, the execution of chunk 330-1 and execution engine 320 will return a result via communication channel 390-4. As will be appreciated, execution engine 320 and/or NBA engine 310 may be a microprocessor, digital signal processor or other well-known processing device, or be combined into any one of the foregoing devices.

Advantageously, representation of the workflow using chunks and self-tuning, to a specific user's context, the execution order of such chunks delivers a troubleshooting script environment with improved customization, effectiveness and reduction in resolution times.

In accordance with a further embodiment, scripting-language execution environment 300 incorporates constraints 380, i.e., a plurality of constraints 380-1 through 380-n, applied to the execution order of chunks 330 to require a particular action only be executed if another action has already been attempted. For example, constraint 380-1 requires a reboot action be preceded by a configuration action, and constraint 380-2 requires an update action be preceded by a configuration action. As will be appreciated, the possibilities for defining constraints are numerous in terms of requiring one action before or after another action, and/or excluding one action if another action has already executed, and/or using any well understood Boolean combinations.

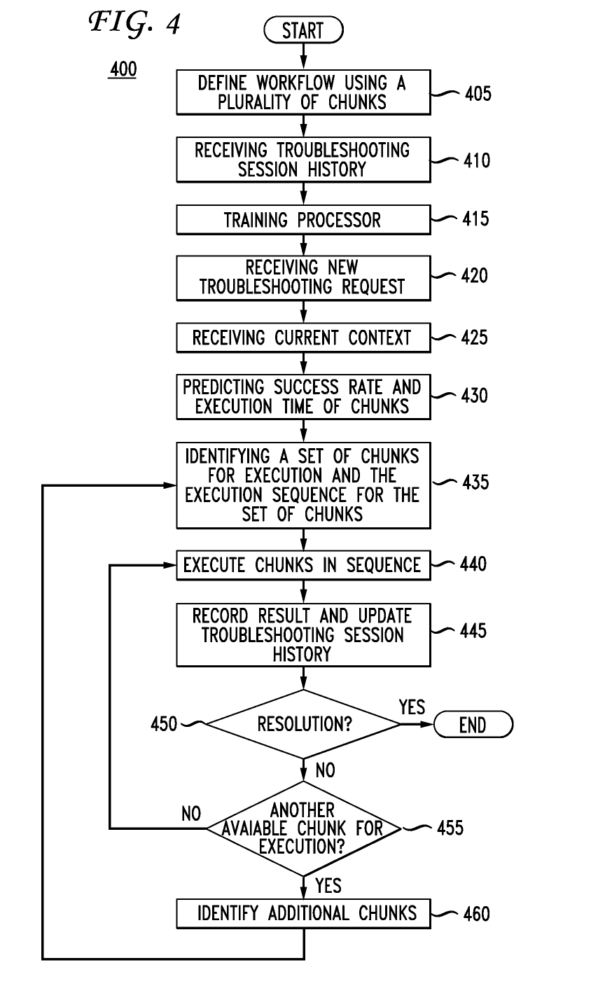

FIG. 4 shows a flowchart of illustrative operations 400 for self-tuning troubleshooting scripts in accordance with an embodiment. In particular, a workflow is defined using a plurality of chunks (see, step 405) as detailed above. Troubleshooting session histories are received (see, step 410) which will serve initially as a historical footprint for identifying, assembling and executing a particular chunk sequence. Illustratively, the troubleshooting histories can be stored in predication data structure 360. In addition, the histories will be utilized (and updated) in training a processor (see, step 415), illustratively, processor 370 as detailed above. A new troubleshooting session request is request is received (see, step 420) along with receiving a current context (see, step 425). As detailed above, the processor will be utilized for predicting a success rate and execution time of chunks (see, step 430) for potential resolution of the new troubleshooting session and identifying the set of chunks for execution and an execution sequence for the set of chunks (see, step 435).

Sequential execution of the identified chunks (see, step 440) will take place (illustratively, as executed by execution engine 320) with the execution result recorded and updating the overall troubleshooting history (see, step 445) with such result for future use. If resolved (see, step 450) the troubleshooting session terminates, otherwise, if there is a next chunk for execution (see, step 455) the sequential execution continues. If all chunks in the identified sequence have been executed without resolution, then execution is passed back to identify additional chunks (see, step 460) to resolve the session and another prediction and execution sequence identified (see, step 430). Again, advantageously, this methodology and the utilization of chunks to represent the workflow allows for a script execution platform that combines the use of such chunk workflow representation with contextual information and a prediction/learning methodology that results in the self-tuning of the chunks. That is, the selection and execution order of chunks is highly optimized in real-time fashion. The representation of the workflow using chunks and optimizing the execution order of such chunks delivers a troubleshooting script environment with improved effectiveness and reduction in resolution times for user issues.

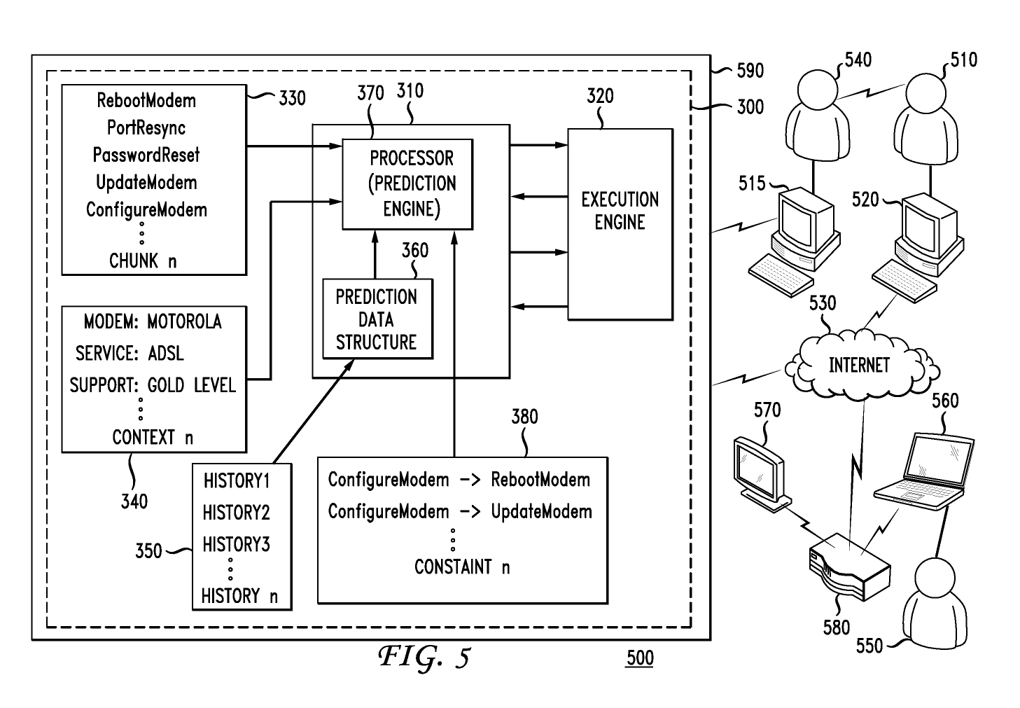

FIG. 5 shows an illustrative schematic block diagram of a troubleshooting workflow environment 500 in accordance with an embodiment. Troubleshooting environment includes user 510 and user 550 where each are operating various devices, i.e., computer 520, computer 560 and television 570 that may require certain troubleshooting from time-to-time with respect to the operation thereof and/or the communication services utilized by such users. For example, user 510 may be experiencing connectivity issues between computer 520 and Internet 530 thereby necessitating a troubleshooting call (e.g., over a land-line or wireless telephone) to customer service representative 540 (e.g., a customer service representative from the customer's communications service supplier). For simplicity, the customer service environment in which customer service representative 540 (and their computer workstation 515) would typically be operating is not shown in full detail but such customer call centers are well-known and understood. Customer service representative 540 will have access to scripting-language environment 300 (as detailed in FIG. 3 and more fully described herein above) and, in accordance with embodiments described above, will attempt to resolve the particular issue identified by user 510. Illustratively, scripting-language environment 300 is delivered by server 590 as operated and maintained by the service provider in a well-known fashion. Of course, as will be appreciated, there are any number of services, devices and associated customer troubleshooting issues that can be addressed in accordance with the embodiments detailed herein.

A further example shown in FIG. 5 is directed to user 550 having computer 560 and television 570, for example, as interconnected on home network 580 in a well-known fashion. Here, user 550 may have a troubleshooting issue with the video services on television 570 and will initiate an interactive troubleshooting session directly with the customer's service provider via Internet 530 in a well-known fashion, and scripting-language environment 300 will again attempt to resolve the identified video services troubleshooting issue interactively with user 550, as detailed herein above.

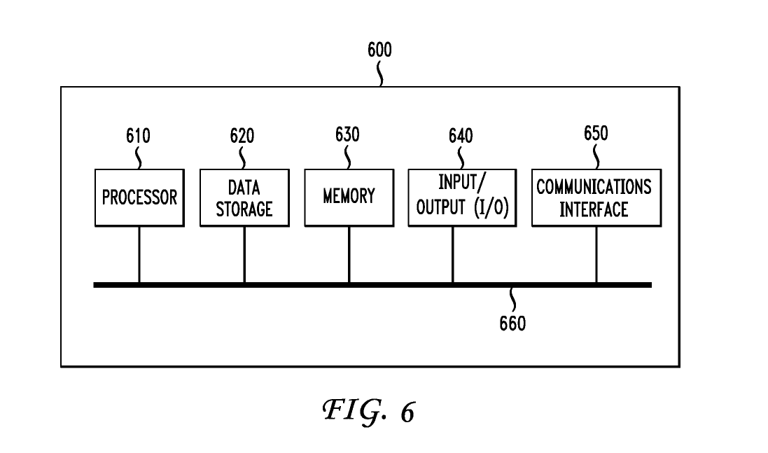

As detailed above, the various embodiments herein can be embodied in the form of methods and apparatuses for practicing those methods. The disclosed methods may be performed by a combination of hardware, software, firmware, middleware, and computer-readable medium (collectively “computer”) installed in and/or communicatively connected to a user device. FIG. 6 is a high-level block diagram of an exemplary computer 600 that may be used for implementing a method for workflow execution in accordance with the various embodiments herein. Computer 600 comprises a processor 610 operatively coupled to a data storage device 620 and a memory 630. Processor 610 controls the overall operation of computer 600 by executing computer program instructions that define such operations. Communications bus 660 facilitates the coupling and communication between the various components of computer 600. The computer program instructions may be stored in data storage device 620, or a non-transitory computer readable medium, and loaded into memory 630 when execution of the computer program instructions is desired. Thus, the steps of the disclosed method (see, e.g., FIG. 4) and the associated discussion herein above) can be defined by the computer program instructions stored in memory 630 and/or data storage device 620 and controlled by processor 610 executing the computer program instructions. For example, the computer program instructions can be implemented as computer executable code programmed by one skilled in the art to perform the illustrative operations defined by the disclosed method. Accordingly, by executing the computer program instructions, processor 610 executes an algorithm defined by the disclosed method. Computer 600 also includes one or more communication interfaces 650 for communicating with other devices via a network (e.g., a wireless communications network) or communications protocol (e.g., Bluetooth®). For example, such communication interfaces may be a receiver, transceiver or modem for exchanging wired or wireless communications in any number of well-known fashions. Computer 600 also includes one or more input/output devices 640 that enable user interaction with computer 600 (e.g., camera, display, keyboard, mouse, speakers, microphone, buttons, etc.).

Processor 610 may include both general and special purpose microprocessors, and may be the sole processor or one of multiple processors of computer 600. Processor 610 may comprise one or more central processing units (CPUs), for example. Processor 610, data storage device 620, and/or memory 630 may include, be supplemented by, or incorporated in, one or more application-specific integrated circuits (ASICs) and/or one or more field programmable gate arrays (FPGAs).

Data storage device 620 and memory 630 each comprise a tangible non-transitory computer readable storage medium. Data storage device 620, and memory 630, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 640 may include peripherals, such as a camera, printer, scanner, display screen, etc. For example, input/output devices 640 may include a display device such as a cathode ray tube (CRT), plasma or liquid crystal display (LCD) monitor for displaying information to the user, a keyboard, and a pointing device such as a mouse or a trackball by which the user can provide input to computer 600.

It should be noted that for clarity of explanation, the illustrative embodiments described herein may be presented as comprising individual functional blocks or combinations of functional blocks. The functions these blocks represent may be provided through the use of either dedicated or shared hardware, including, but not limited to, hardware capable of executing software. Illustrative embodiments may comprise digital signal processor (“DSP”) hardware and/or software performing the operation described herein. Thus, for example, it will be appreciated by those skilled in the art that the block diagrams herein represent conceptual views of illustrative functions, operations and/or circuitry of the principles described in the various embodiments herein. Similarly, it will be appreciated that any flowcharts, flow diagrams, state transition diagrams, pseudo code, program code and the like represent various processes which may be substantially represented in computer readable medium and so executed by a computer, machine or processor, whether or not such computer, machine or processor is explicitly shown. One skilled in the art will recognize that an implementation of an actual computer or computer system may have other structures and may contain other components as well, and that a high level representation of some of the components of such a computer is for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A computer-implemented method for executing a workflow, the method comprising:
determining an execution history for one or more of a plurality of chunks of the workflow, each chunk of the plurality of chunks defining at least a single action of the workflow;
determining at least one ordered set of chunks from the plurality of chunks using the execution history of the plurality of chunks; and
executing the at least one ordered set of chunks.

2. The computer-implemented method of claim 1, further comprising defining at least one of the plurality of chunks as a semantic structure that includes a gate, an action, and a verification using one or more commands of a scripting language.

3. The computer-implemented method of claim 1 further comprising:
determining a plurality of context variables and a plurality of constraints; and,
determining the at least one ordered set of chunks from the plurality of chunks using, in conjunction with the execution history of the plurality of chunks, the plurality of context variables and the plurality of constraints.

4. The computer-implemented method of claim 3 further comprising:
training a processor, for determining the at least one ordered set of chunks, using the execution history of the plurality of chunks;
determining a resolution for at least one chunk of the at least one ordered set of chunks upon execution thereof; and
updating the execution history with the resolution.

5. The computer-implemented method of claim 4 further comprising:
training the processor, for determining the at least one ordered set of chunks, using the plurality of context variables and the plurality of constraints; and
determining a success rate and an execution time for selected ones of the plurality of chunks.

6. The computer-implemented method of claim 1 wherein the workflow is a troubleshooting workflow related to communications services.

7. The computer-implemented method of claim 6 wherein particular ones of the context variables of the plurality of context variables define a context associated with a user of the communications services.

8. The computer-implemented method of claim 3 wherein the at least one ordered set of chunks is in a sequential order, and the plurality of constraints define at least one constraint that defines the sequential order between a first chunk of the at least one ordered set of chunks and a second chunk of the at least one ordered set of chunks.

9. An apparatus for delivering a workflow, the apparatus comprising:
a processor configured to:
determine an execution history for one or more of a plurality of chunks of the workflow, each chunk of the plurality of chunks defining at least a single action of the workflow; and
determine at least one ordered set of chunks from the plurality of chunks using the execution history of the plurality of chunks.

10. The apparatus of claim 9 wherein the processor is further configured to utilize at least one of the plurality of chunks in a semantic structure that includes a gate, an action, and a verification.

11. The apparatus of claim 9 wherein the processor is further configured to determine a success rate and an execution time for selected ones of the chunks of the plurality of chunks.

12. The apparatus of claim 9 wherein the processor is further configured to execute the at least one ordered set of chunks.

13. The apparatus of claim 12, wherein the processor is further configured to:
determine a resolution for at least one chunk of the at least one ordered set of chunks upon execution thereof; and
update the execution history with the resolution.

14. The apparatus of claim 10 wherein the gate defines an applicability of a particular action, the action is an operation directed to resolving the workflow, and the verification identifies a resolution indication for the particular action.

15. The apparatus of claim 9 wherein the processor is further configured to utilize a plurality of context variables, and use the plurality of context variables in conjunction with the execution history of the plurality of chunks, to determine the at least one ordered set of chunks.

16. The apparatus of claim 15 wherein the processor is configured to utilize at least one of the plurality of context variables based upon a troubleshooting request initiated by a user.

17. The apparatus of claim 15 wherein the processor is further configured to utilize a plurality of constraints, in conjunction with the execution history of the plurality of chunks and the plurality of context variables, to determine the at least one ordered set of chunks.

18. A non-transitory computer-readable medium storing computer program instructions for executing a workflow, the computer program instructions, when executed on a processor, cause the processor to perform operations comprising:
determining an execution history for one or more of a plurality of chunks of the workflow, each chunk of the plurality of chunks defining at least a single action of the workflow;
determining at least one ordered set of chunks from the plurality of chunks using the execution history of the plurality of chunks; and
executing the at least one ordered set of chunks.

19. The non-transitory computer-readable medium of claim 18 wherein the operations further comprise:
determining a plurality of context variables and a plurality of constraints for the plurality of chunks; and
determining the at least one ordered set of chunks from the plurality of chunks using, in conjunction with the execution history of the plurality of chunks, the plurality of context variables and the plurality of constraints.

20. The non-transitory computer-readable medium of claim 19 wherein at least one of the plurality of chunks is defined as a semantic structure that includes a gate, an action, and a verification using one or more commands of a scripting language, and the operations further comprising:
training a processor, for determining the at least one ordered set of chunks, using the execution history of the plurality of chunks;
determining a resolution for at least one chunk of the at least one ordered set of chunks upon execution thereof; and
updating the execution history with the resolution.
